(19) United States
(12) Patent Application Publication
(10) Pub. No.: US 2023/0408370 A1
(43) Pub. Date: Dec. 21, 2023

(54) DEVICE FOR VERIFYING VEHICLE LAMP OPERATION

(71) Applicant: John C. Dunham, Loudon, TN (US)

(72) Inventor: John C. Dunham, Loudon, TN (US)

(21) Appl. No.: 17/844,663

(22) Filed: Jun. 20, 2022

(51) Int. Cl. G01M 11/02; G01M 11/06

(52) U.S. Cl. CPC G01M 11/0207; G01M 11/06

(57) ABSTRACT

The vehicle lamp operation verification device provides for a preferred and alternate embodiment that indicates proper operation of head lights, daytime running lights, cornering lights, turn signal lights, parking lights, brake lights, and the like from inside the passenger compartment of a motor vehicle or at a remote position away from the light assembly. The preferred embodiment is installed upon a motor vehicle, herein shown as an automobile. The alternate device utilizes suction cups to couple the device to a handheld view panel. Further, the device can be used with multiple types of light assemblies.

### FIELD OF THE INVENTION

This invention relates to moving vehicle lamps. More particularly, it relates to a device for verifying operation of vehicle lamps.

### BACKGROUND

A lighting system of a motor vehicle consists of lighting and signaling devices mounted or integrated at the front, rear, sides, and in some cases the top of a motor vehicle. They illuminate the roadway ahead for the driver and increase the vehicle's visibility, allowing other drivers and pedestrians to see its presence, position, size, and direction of travel, and its driver's intentions.

Early road vehicles used fueled lamps, before the availability of electric lighting. The Ford Model T used carbide lamps for headlamps and oil lamps for tail lamps. It did not have all-electric lighting as a standard feature until several years after introduction. Dynamos for automobile headlamps were first fitted around 1908 and became commonplace in 1920s automobiles.

Silent film star Florence Lawrence is often credited with designing the first “auto signaling arm”, a predecessor to the modern turn signal, along with the first mechanical brake signal. She did not patent these inventions, however, and as a result she received no credit for—or profit from—either one. Tail lamps and brake lamps were introduced around 1915, and by 1919 “dip” headlamps were available. The sealed beam headlamp was introduced in 1936 and standardized as the only acceptable type in the US in 1940. Self-cancelling turn signals were developed in 1940. By 1945 headlamps and signal lamps were integrated into the body styling. Halogen headlamp light sources were developed in Europe in 1960. HID headlamps were produced starting in 1991. In 1993, the first LED tail lamps were installed on mass-production automobiles. LED headlamps were introduced in the first decade of the 21st century.

One of the main concerns with light assemblies is not knowing the current condition or status of a light assembly. This can cause driving concerns or dangerous conditions that can be avoided.

Accordingly, and in light of the foregoing, there is a need and desire to have a device that can be connected to any or all lighting assemblies for a motor vehicle and to give a easy to read status of each particular lighting assembly. Furthermore, it would also be advantageous for the device to be easily moved to another vehicle, easy to use and cost efficient.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of the vehicle lamp operation verification device 10, according to the preferred embodiment of the present invention;

FIG. 2 is a sectional view of the vehicle lamp operation verification device 10, as seen along a line I-I, as shown in FIG. 1, according to the preferred embodiment of the present invention;

FIG. 3 is a sectional view of the vehicle lamp operation verification device 10, as seen along a line II-II, as shown in FIG. 1, according to the preferred embodiment of the present invention;

FIG. 4 is a perspective view of an alternate vehicle lamp operation verification device 11, according to the alternate embodiment of the present invention;

FIG. 5 is a sectional view of the alternate vehicle lamp operation verification device 11, as seen along a line III-III, as shown in FIG. 4, according to the alternate embodiment of the present invention;

FIG. 6 is a sectional view of the alternate vehicle lamp operation verification device 11, as seen along a line IV-IV, as shown in FIG. 4, according to the alternate embodiment of the present invention; and,

FIG. 7 is a side sectional view of the alternate vehicle lamp operation verification device 11, as seen along a line IV-IV, as shown in FIG. 4, according to the alternate embodiment of the present invention.

### DESCRIPTIVE KEY

10 vehicle lamp operation verification device
11 alternate vehicle lamp operation verification device
15 motor vehicle
20 vehicle lamp
25 light assembly
25a first light assembly
25b second light assembly
30 fiber optic cable
30a alternate first fiber optic cable
30b alternate second fiber optic cable
35 passenger compartment
40 mimic panel
45 lamp socket
50 plug connector
55 wiring harness
60 fiberoptic cable housing
65 alignment tube
70 top view vehicle image
75 fiber optic cable termination
80 parking light
85 brake light
90 turn signal light
95 head light
100 daytime running light
105 cornering light
110a first suction cup
110b second suction cup
115 single fiber optic cable
120 combiner
125 dual fiber optic cable
135 cup assembly
140 suction cup handle
145 sealant
150 handle
151 rear cover
155 fastener
160 lens cover
165a first illumination
165b second illumination

### DESCRIPTION OF THE PREFERRED EMBODIMENTS

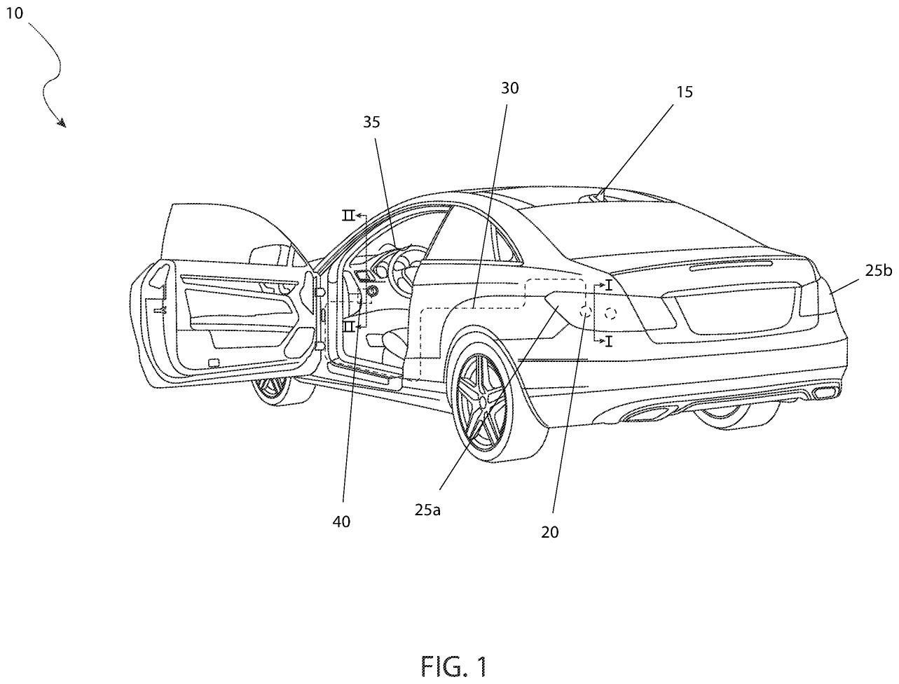

The best mode for carrying out the invention is presented in terms of its preferred embodiment, herein depicted within FIGS. 1 through 7. However, the invention is not limited to the described embodiment, and a person skilled in the art will appreciate that many other embodiments of the invention are possible without deviating from the basic concept of the invention and that any such work around will also fall under scope of this invention. It is envisioned that other styles and configurations of the present invention can be easily incorporated into the teachings of the present invention, and only one (1) particular configuration shall be shown and described for purposes of clarity and disclosure and not by way of limitation of scope. All of the implementations described below are exemplary implementations provided to enable persons skilled in the art to make or use the embodiments of the disclosure and are not intended to limit the scope of the disclosure, which is defined by the claims.

The terms “a” and “an” herein do not denote a limitation of quantity, but rather denote the presence of at least one (1) of the referenced items.

### 1. Detailed Description of the Figures

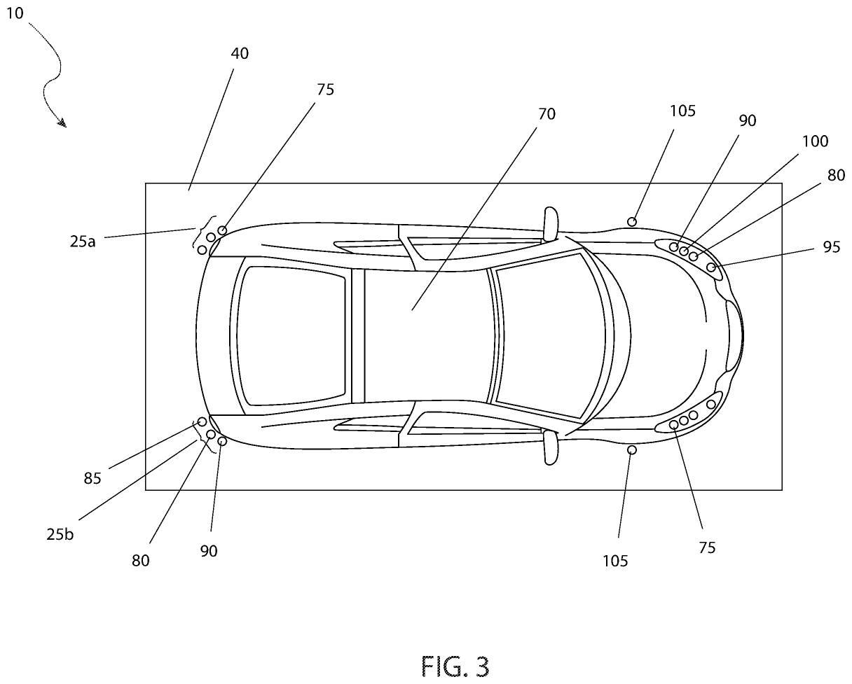

Referring now to FIG. 1 and FIG. 3, a perspective view of the vehicle lamp operation verification device 10, according to the preferred embodiment of the present invention is disclosed. The vehicle lamp operation verification device (herein also described as the “device”) 10, provides for a preferred and alternate embodiment that indicates proper operation of head lights 95, daytime running lights 100, cornering lights 105, turn signal lights 90, parking lights 80, brake lights 85, and the like from inside the passenger compartment 35 of a motor vehicle 15 or at a remote position away from the light assembly 25. The preferred embodiment is installed upon a motor vehicle 15, herein shown as an automobile. However, as the teachings of the device 10 are applicable to any type of motor vehicle 15, and as such, the use of the device 10 on any specific type of motor vehicle 15 is not intended to be a limiting factor of the present invention.

A vehicle lamp 20, herein shown by a dashed line due to its hidden nature, is provided as a conventional part of the motor vehicle 15 in a typical light assembly 25. The light assembly 25 shown is in the location of the fiber optic cable 30 solely for purposes of illustration. However, other light assembly 25 including but not limited to: brake lights 85, turn signal lights 90, backup lights, cornering lights 105, daytime running lights 100, fog lights, parking lights 80, head lights 95, emergency flashers, and the like, are intended to be provided with the functionality of the device 10. A fiber optic cable 30 is routed from the light assembly 25 through the interior of the motor vehicle 15 (as shown via a dashed line due to its hidden state) to the passenger compartment 35, where the fiber optic cable 30 terminates in a mimic panel 40. Note that each individual light assembly 25 on the motor vehicle 15 is provided with its own independent fiber optic cable 30. Each fiber optic cable 30 begins at a unique light assembly 25 and terminates at the sole mimic panel 40. As the mimic panel 40 does not require constant monitoring, it may be located on the dashboard (as shown), center console, or a semi-accessible location as a glove compartment, console compartment or the like. The exact location of the mimic panel 40 in the passenger compartment 35 is not intended to be a limiting factor of the present location. Additional details on the connection of the fiber optic cable 30 to the light assembly 25 as well as additional details on the mimic panel 40 will be provided herein below. The user will verify proper operation of each vehicle lamp 20 in every light assembly 25 via the mimic panel 40.

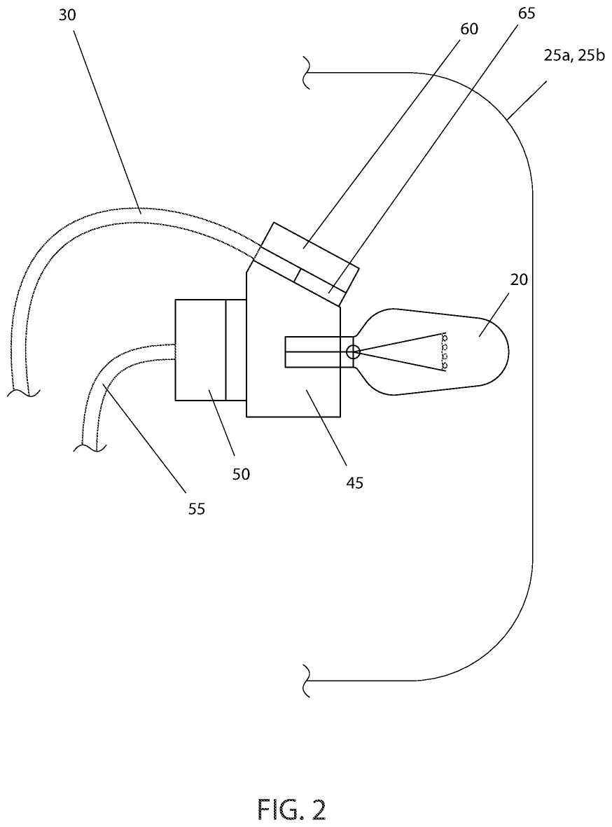

Referring next to FIG. 2, a sectional view of the device 10, as seen along a line I-I, as shown in FIG. 1, according to the preferred embodiment of the present invention is depicted. The vehicle lamp 20 is housed within the light assembly 25 as typically expected. A lamp socket 45 provides for an electrical connection to the vehicle lamp 20. A plug connector 50 provides for an electrical connection between the lamp socket 45 and a wiring harness 55 as typically expected. The fiber optic cable 30 enters a fiberoptic cable housing 60 provided as part of the lamp socket 45 and terminates approximately halfway inside. The termination provides for a hollow alignment tube 65 that provides direct line of sight to the vehicle lamp 20. The line of sight greatly reduces the occurrence of extraneous ambient light sources that may otherwise contribute to false positives on the mimic panel 40 (as shown in FIG. 1).

Referring now to FIG. 3, a sectional view of the device 10, as seen along a line II-II, as shown in FIG. 1, according to the preferred embodiment of the present invention is shown. The mimic panel 40 is provided with a top view vehicle image 70 that represents the motor vehicle 15 (as shown in FIG. 1). Multiple fiber optic cable terminations 75 are provided on the top view vehicle image 70. Various light assembly 25 such as parking lights 80, brake lights 85, turn signal lights 90, head lights 95, daytime running lights 100, and cornering lights 105 are monitored via the mimic panel 40. A dedicated fiber optic cable terminations 75 for each fiber optic cable 30 (as shown in FIG. 1) is provided on the top view vehicle image 70. The top view vehicle image 70 will vary per each make and model of motor vehicle 15. It is noted that the color of the vehicle lamp 20 such as clear, amber, or the like, will be reproduced on the fiber optic cable terminations 75.

Referring next to FIGS. 1, 4, and 5, a perspective view of an alternate vehicle lamp operation verification device (herein also described as the “alternate device”) 11, according to the alternate embodiment of the present invention is disclosed. The alternate device 11 as depicted would be used for temporary usage where verification of a vehicle lamp 20 operation is required, and no other individual is present to assist in activating switches, pressing pedals, or the like in the passenger compartment 35 of a motor vehicle 15 while another individual is present at the light assembly 25 to visually verify operation. Such temporary usage may utilize a first suction cup 110a to be removably placed on a first light assembly 25a, and a second suction cup 110b to be removably placed on a second light assembly 25b. The verification process may include proper operation before usage of the motor vehicle 15, operation of lights on a trailer, verification of a repair or replacement of the vehicle lamp 20, or the like.

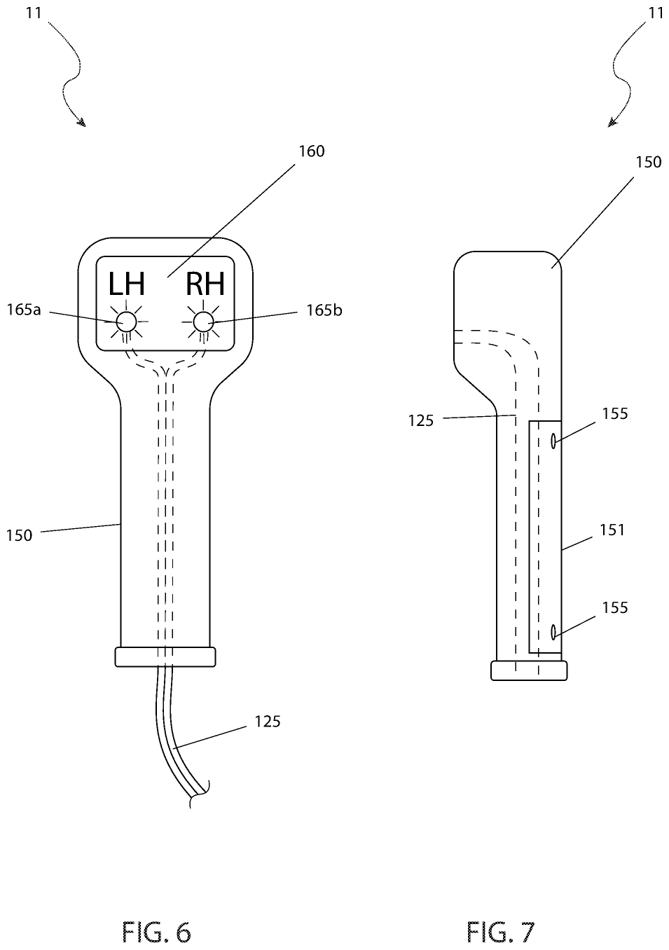

Both suction cups 110a, 110b are attached to each light assembly 25a, 25b in direct visual alignment with the vehicle lamp 20 (as shown in FIGS. 1 and 2). The alternate device 11 provides for a left-hand and a right-hand version for a total of two (2) suction cups 110a, 110b. Each suction cup 110a, 110b is attached to a respective first or second fiber optic cable 30a, 30b which combines at a combiner 120 to form a dual fiber optic cable 125. The dual fiber optic cable 125 terminates in a handle 150. The opposite end of the dual fiber optic cable 125 separates back into two (2) fiber optic cables 30a, 30b, where each cable 30a, 30b terminates into a socket 165a, 165b in back of a viewing portion above the gripping portion of the handle 150 (see FIG. 6). The user would hold the gripping portion of the handle 150 of the alternate device 11 in hand while verifying operation of the vehicle lamp 20 of either or both light assemblies 25a, 25b while pressing pedals, activating switches or the like. The dual fiber optic cable 125 is envisioned to be approximately thirty feet (30 ft.) for typical usage. However, other lengths, both shorter or longer may be used.

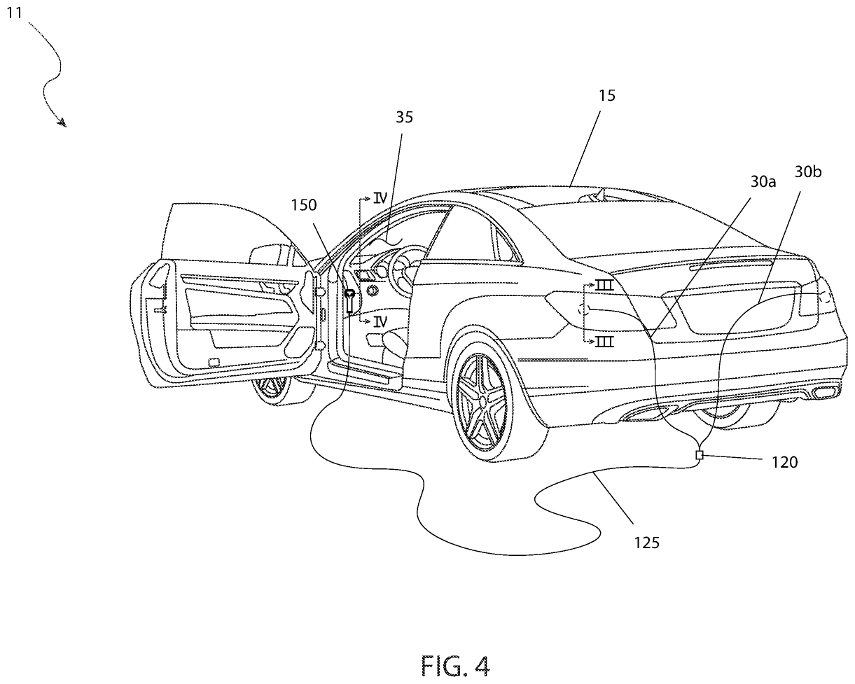

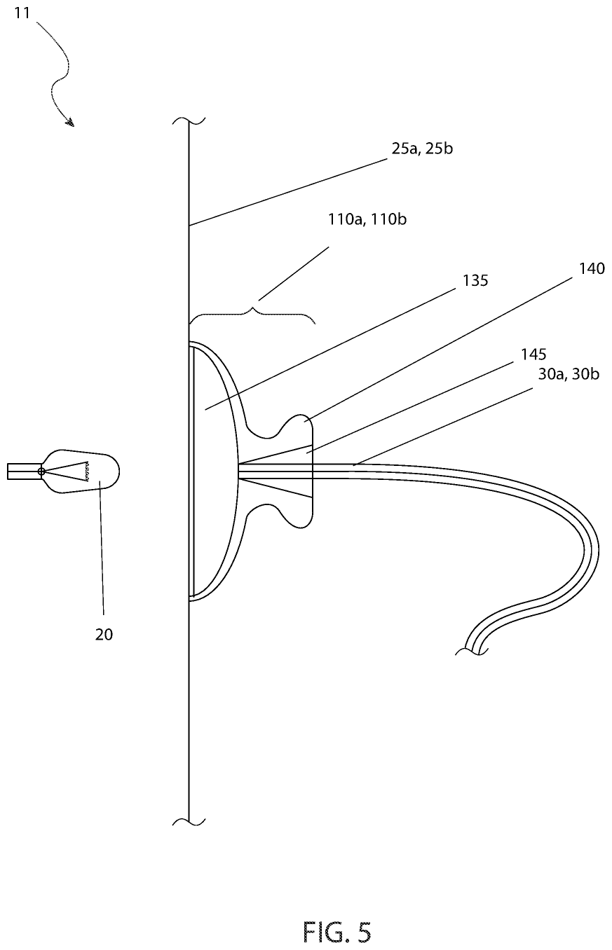

Referring now to FIG. 5, a sectional view of the alternate device 50, as seen along a line III-III, as shown in FIG. 4, according to the alternate embodiment of the present invention is depicted. Each suction cup 110a, 110b includes a cup assembly 135 which adheres to a respective light assembly 25a, 25b via suction. A suction cup handle 140 is provided to assist in removal and placement of the suction cup 110. The respective fiber optic cable 30a, 30b is inserted through the center of the suction cup handle 140. A sealant 145 is used to hold the respective fiber optic cable 30a, 30b in place as well as provide an air-tight seal for the cup assembly 135. The respective fiber optic cable 30a, 30b is in general alignment with the vehicle lamp 20 of the respective light assembly 25a, 25b.

Referring to FIG. 6, a sectional view of the handle 150 of the alternate device 11, as seen along a line IV-IV, as shown in FIG. 4, according to the alternate embodiment of the present invention is shown. The handle 150 provides for the termination of the dual fiber optic cable 125 and the fiber optic cables 30a, 30b. The back side of the handle 150 of the alternate device 11 includes a rear cover 151 that is removably attached thereto and held together by fasteners 155, such as screws, in a “clam-shell” configuration. A transparent lens cover 160 is provided over the viewing portion on a front side of the handle 150 of the alternate device 11. The first fiber optic cable 30a terminates in a socket behind the left-hand side of the lens cover 160 and is preferably labelled “LH”. The second fiber optic cable 30b terminates in a socket behind the right-hand side of the lens cover 160 and is preferably labelled “RH”. The lens cover 60 is located atop these terminal ends of the fiber optic cables 30a, 30b to prevent damage thereto. First illumination 165a being emitted from the first light assembly 25a (in the exemplary embodiment as the left-hand) and transmitted by the first fiber optic cable 30a and second illumination 165b being emitted from the second light assembly 25b (in the exemplary embodiment as the right-side) and transmitted by the second fiber optic cable 30b can be observed through the lens cover 160. Illumination 165a, 165b is viewed on the left-hand or right-hand side of the viewing portion, respectively.

### 2. Operation of the Preferred Embodiment

The preferred embodiment of the present invention can be utilized by the common user in a simple and effortless manner with little or no training. It is envisioned that the device 10 would be constructed in general accordance with FIG. 1 through FIG. 3, and the alternate device 11 in general accordance with FIGS. 4-7. The preferred embodiment of FIG. 1 would best be installed by motor vehicle 15 manufacturers as standard or optional equipment due to the specific integration of the lamp socket 45, the fiberoptic cable housing 60, the mimic panel 40, and the need to include the fiber optic cables within each specific wiring harness. The user would procure the alternate device 11, as seen in FIG. 4, from conventional procurement channels such as automotive supply stores, discount stores, mail order and internet supply houses and the like. Special attention would be paid to the overall length of the dual fiber optic cable 125 to ensure adequate length between the passenger compartment 35 and the desired light assembly 25a, 25b.

The preferred embodiment of FIG. 1 is ready to utilize as procured from the original equipment manufacturer (OEM). At any time, the user can verify proper operation of any specific vehicle lamp 20 in any specific light assembly 25 by energizing the vehicle lamp 20 in a normal manner via a switch or pedal. Operation is then verified by observing the corresponding fiber optic cable terminations 75 on the top view vehicle image 70. Such verification process can be repeated for each specific vehicle lamp 20 as required and as needed.

The alternate device 11 of FIG. 4 would be used in the following manner: the first suction cup 110a would be installed on a corresponding first light assembly 25a directly over the desired vehicle lamp 20; the second suction cup 110b would be installed on a corresponding second light assembly 25b directly over the desired vehicle lamp 20; the user would then energize the specific vehicle lamp 20 by pressing pedals or activating switches in the passenger compartment 35 and subsequently verifying that either or both first illumination 165a and second illumination 165b is transmitted and viewable from the viewing portion through the lens cover 160 of the handle 150. After verification is complete, the suction cups 110a, 110b are removed. In the exemplary embodiment, the first light assembly 25a is on the left-hand side and the second light assembly 25b is on the right-hand side. This process may be repeated again as needed.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

What is claimed is:

1. A vehicle lamp operation verification device for verifying operations of lamp on a motor vehicle, the device comprising:
a light assembly, the light assembly comprising;
a lamp socket;
a plug connector, the plug connector being coupled to an electrical connection and the lamp socket;
a wiring harness, the wiring harness being for preventing wires from becoming tangled or damaged; and
a fiber optic housing, the fiber optic housing being coupled to the lamp socket;
a fiber optic cable, the fiber optic cable being inserted a predetermined distance into the fiber optic housing;
a mimic panel, the mimic panel having a plurality of illuminations and a lens cover, the mimic panel configured to receive one or more fiber optic cables; the mimic panel being coupled to the fiber optic cable, the mimic panel displaying one or more of the illuminations, each of the laminations associated with one of the fiber optics cables.

2. The device according to claim 1, wherein the light assembly being brake lights.

3. The device according to claim 1, wherein the light assembly being turn signal lights.

4. The device according to claim 1, wherein the light assembly having a vehicle lamp.

5. The device according to claim 1, wherein the predetermined distance being halfway into the fiber optic housing.

6. The device according to claim 1, wherein the mimic panel further comprising:
a suction cup assembly, the suction cup assembly having a first suction cup and a second suction cup, the suction cup assembly coupled to the mimic panel, wherein the suction cup assembly is configured to couple the first suction cup and the second suction cup to a dashboard of the motor vehicle.

7. The device according to claim 6, wherein the suction cup assembly comprising a suction cup handle, the suction cup hand being coupled to the mimic panel.

8. The device according to claim 7, wherein the suction cup handle having a first suction cup and a second suction cup, wherein the first suction cup and the second suction cup are configured to be removably coupled to the dashboard.

9. The device according to claim 1, wherein the mimic panel further having a handle, the handle being for portability of the mimic panel.

10. The device according to claim 1, wherein the motor vehicle is an automobile.

11. The device according to claim 1, wherein the mimic panel further comprising:
a rear cover, the rear cover having a plurality of fasteners, the fasteners for removably securely coupling the rear cover to the mimic panel.
